(19) United States
(12) Patent Application Publication
(10) Pub. No.: US 2026/0134052 A1
(43) Pub. Date: May 14, 2026

(54) METHODS AND APPARATUSES FOR AN ARITHMETIC LOGIC UNIT OF A COMPUTATIONAL PROCESSOR

(71) Applicant: Taiwan Semiconductor Manufacturing Company, Ltd., Hsin-Chu (TW)

(72) Inventors: Win-San KHWA, Taipei City (TW); Ashwin Sanjay LELE, San Jose, CA (US); Bo ZHANG, San Jose, CA (US); Meng-Fan CHANG, Taichung City (TW)

(21) Appl. No.: 18/946,311

(22) Filed: Nov. 13, 2024

(51) Int. Cl. G06F 17/11; G06F 5/01; G06F 17/17

(52) U.S. Cl. CPC G06F 17/11; G06F 5/01; G06F 17/17

(57) ABSTRACT

Embodiment described herein provide systems, apparatuses and methods for an arithmetic logic unit compute an exponential of an input data value, a splitter circuit splits an input data value into an integer portion and a fractional portion. A scheduler circuit dynamically determines a number of terms for approximating an exponential of the factional portion, e.g., based on the fractional part of the input data value. A Taylor expansion computation circuit computing a sum of the number of Taylor expansion terms for the compensated fractional portion. The exponential of the input data value is then computed as a multiplication of the exponential of the integer portion and the approximated exponential of the fractional portion.

### BACKGROUND

An artificial intelligence (AI) system may be built on a software-based neural network model implemented on one or more AI accelerators, such as a graphics processing unit (GPU), tensor processing units (TPUs), and/or the like. The AI accelerator may comprise a specialized hardware component and/or device to accelerate the execution of AI and machine learning workloads. Existing AI accelerators and/or processors largely rely on software frameworks and libraries to perform complex computational tasks. The power consumption of such AI accelerators and/or processors can be significant due to the intense computational demands of AI systems.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an example of neural network model involving computational steps to performing a classification task, according to one or more embodiments described herein.

FIG. 2 is a simplified diagram illustrating an example structure of an exponential computation circuit, according to one or more embodiments described herein.

FIG. 3 is a simplified diagram illustrating an alternative example structure of an exponential computation circuit, according to one or more embodiments described herein.

FIG. 4 is a simplified diagram illustrating an example structure of a splitter circuit described in FIG. 3, according to one or more embodiments described herein.

FIG. 5 is a simplified diagram illustrating an example structure of a compensation circuit described in FIG. 3, according to one or more embodiments described herein.

FIG. 6 is a simplified logic flow diagram illustrating a workflow of the compensation circuit described in FIG. 5, according to one or more embodiments described herein.

FIG. 7 is an example logic flow chart illustrating a process for operating an exponential computation circuit described in FIGS. 1-6, according to embodiments described herein.

FIG. 8 is a simplified diagram illustrating a computing device implementing a neural network on an AI accelerator comprising the circuit structures described in FIGS. 1-7, according to one embodiment described herein.

FIGS. 9A-9B are example performance charts illustrating error and power efficiency of the exponential computation circuit described in FIGS. 1-8, according to one embodiment described herein.

### DETAILED DESCRIPTION

The following disclosure provides many different embodiments, or examples, for implementing different features of the invention. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

In recent years, the rapid advancements in artificial intelligence (AI) and machine learning have significantly impacted various industries, from healthcare and finance to automotive and consumer electronics. As AI systems become increasingly sophisticated, their computational demands have escalated, driving the need for more efficient and powerful processing solutions. Traditional central processing units (CPUs) often struggle to keep pace with these demands, leading to the widespread adoption of AI accelerators such as graphics processing units (GPUs) and tensor processing units (TPUs). GPUs and TPUs are better suited for AI applications than CPUs due to their ability to handle the massive parallel processing required by AI and machine learning tasks. Unlike CPUs, which are optimized for general-purpose computing, GPUs and TPUs are designed to execute thousands of operations simultaneously, making them good candidates for processing large datasets and complex algorithms. This parallelism significantly accelerates the training and inference processes in AI models, resulting in faster and more efficient computation. Additionally, GPUs and TPUs are optimized for the specific mathematical operations that underpin AI workloads, further enhancing their performance in these applications.

AI accelerators have emerged as critical components in the deployment of AI models, particularly in tasks that require massive parallel processing capabilities, such as deep learning. These specialized hardware components are designed to optimize the performance of AI workloads, enabling faster processing times and more efficient utilization of resources. However, this increased performance often comes at the cost of higher power consumption, posing significant challenges in terms of energy efficiency and thermal management.

The instant application relates to computational circuits, and more specifically to methods and apparatuses for an application-specific circuit for computing an exponential of an input data value. Embodiment described herein provide an arithmetic logic unit (ALU) circuit for computing an exponential of an input data value, such as a Brain Floating Point 16-bit (BF16), half-point floating point 16-bit (FP16), 16-bit floating-point data types used primarily in machine learning and AI computations. In one embodiment, to compute an exponential of an input data value, a splitter circuit splits an input data value into an integer portion and a fractional portion. A compensation circuit is configured to restrict the fractional portion to be less than 0.5 and thus generate a compensated integer part and a compensated fractional part. Instead of using a pre-fixed number of Taylor expansion terms, a scheduler circuit dynamically determines a number of terms for approximating an exponential of the factional portion, e.g., based on the fractional part of the input data value. A Taylor expansion computation circuit computing a sum of the number of Taylor expansion terms for the compensated fractional portion. The exponential of the input data value is then computed as a multiplication of the exponential of the integer portion and the approximated exponential of the fractional portion.

In this way, the exponential computation ALU may be applicable in AI accelerators as an on-chip ALU for complex operations based on exponential computation, e.g., softmax and SiLU, and/or the like. Such hardware-based computation allows fast convergence and high accuracy for computations, as well as efficient circuit area usage and low energy consumption. Also, the hardware-based exponential computation ALU unit requires fewer GPU memory accesses, compared to software-based computation on GPUs.

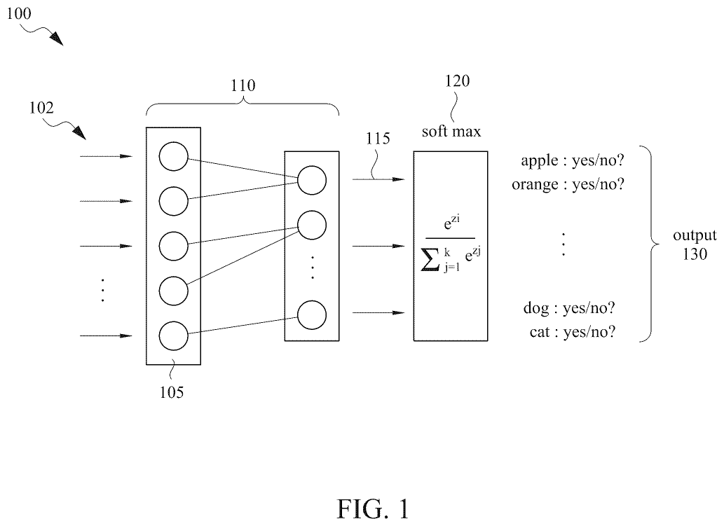

FIG. 1 illustrates an example of neural network model 100 involving computational steps to performing a classification task, according to one or more embodiments described herein. In one embodiment, a neural network 100 comprises a computing system that is built on a collection of connected units or nodes, referred to as neurons 105. Neurons are often connected by edges, and an adjustable weight is often associated with the edge. The neurons are often aggregated into layers 110 such that different layers may perform different transformations on the respective input and output transformed input data onto the next layer.

For example, an input layer receives the input data 102 as each neuron receives input signals, performs a weighted sum of the inputs according to weights assigned to each connection, and then applies an activation function associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, SiLU, and/or the like. In this way, after a number of layers, input data 102 received at the input layer is transformed into rather different values indicative data characteristics corresponding to a task that the neural network structure has been designed to perform.

For example, the input data 102 may comprise an image, and the neural network 100 may be a classification model trained to classify an object in the input image. The output layer may output probabilities 115 indicating a likelihood that the input image may contain one of pre-defined object classes, e.g., apple, orange, . . . , dog, cat. A softmax operation 120 may be performed based on the output probabilities 115 to generate a final binary output 130 of classification. In this process, the operation of the neural network 100 involves a significant number of exponential computations, e.g., in the softmax operation, in a SiLU operation, and/or the like.

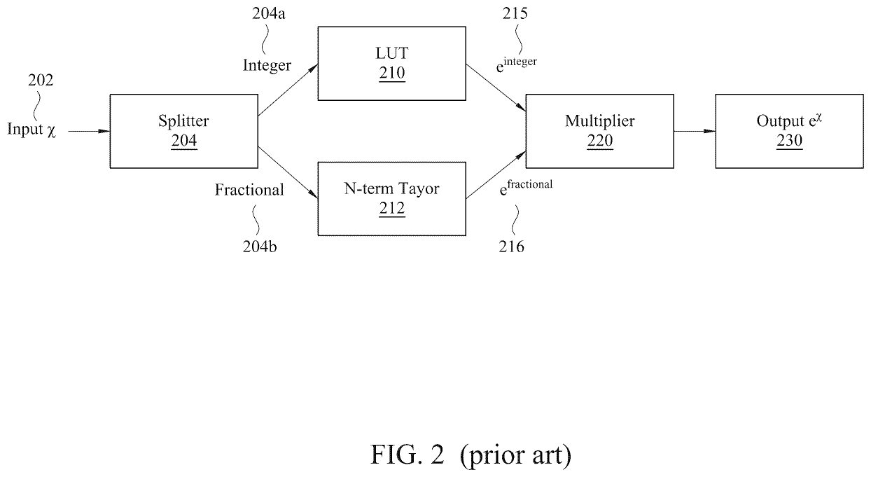

FIG. 2 is a simplified diagram illustrating an example structure of a traditional exponential computation circuit, according to one or more embodiments described herein. For example, the exponential computation circuit comprises a splitter circuit 204, a lookup (LUT) table circuit 210, a Taylor term computation circuit 212, and a multiplier 220.

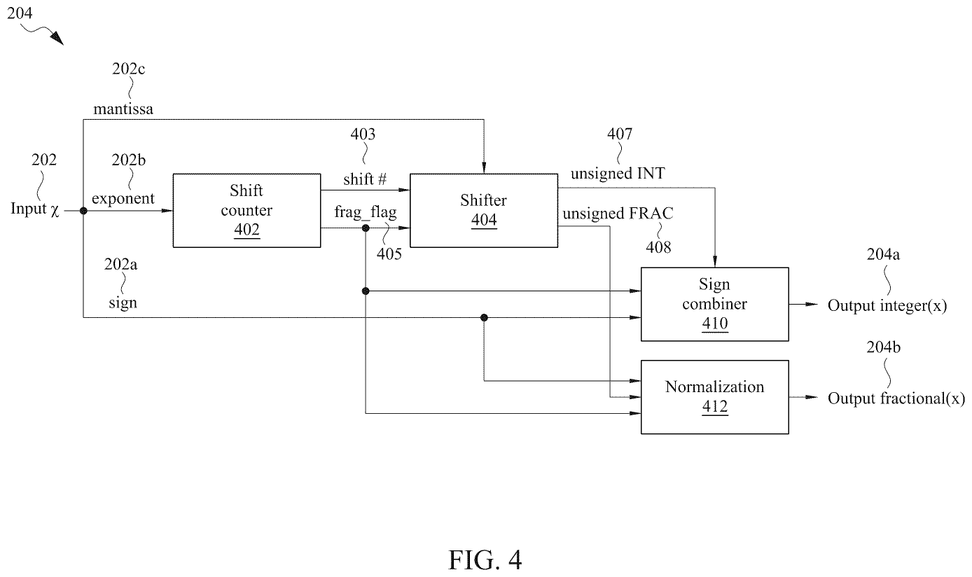

Given an input data value 202, the splitter circuit 204 is configured to split the input data into an integer part 204a and a fractional part 204b. An example circuit structure of the splitter circuit 204 is further described below in FIG. 4.

For the integer part 204a, the LUT circuit 210 may retrieve a pre-stored exponential value 215 for the integer 204a. For the fractional part 204b, the Talor term computation circuit 212 may compute a sum of a finite number of Taylor expansion terms of the fractional part 204b as an approximation of the exponential value 216. The multiplier 220 may then multiple the exponential of the integer part 215 and the exponential of the fractional part 216 to output the final exponential value 230.

In this exponential computation circuit shown in FIG. 2, the Taylor term computation circuit 212 adopts a pre-defined fixed number of terms for Taylor expansion e.g., N=3, 4, 5, etc. Given a fixed number N but with varying fractional parts for different input values 202, computational accuracy of the exponential 216 may be sacrificed for exponential of large fractional parts. On the other hand, using the same number N for smaller fractional parts would waste computation energy/cycles. Therefore, it remains challenging to design the Taylor term computation circuit 212 with an optimal number of Taylor terms to balance computational cost/energy and accuracy.

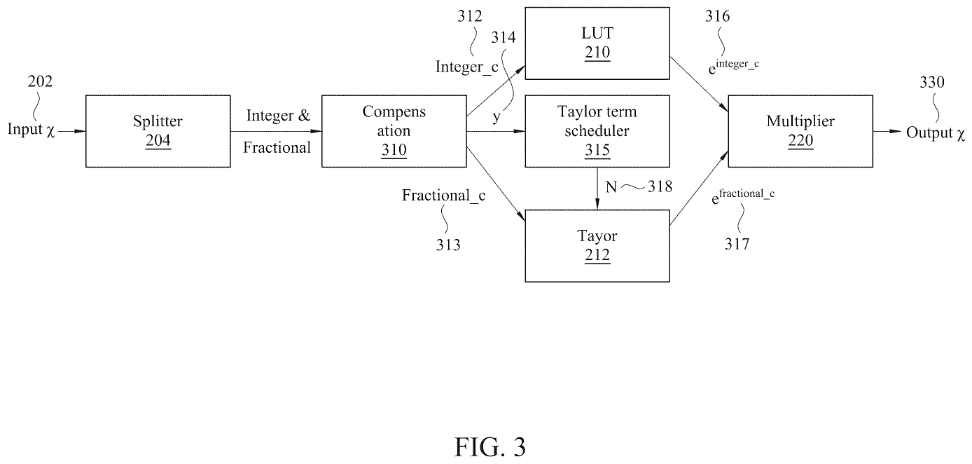

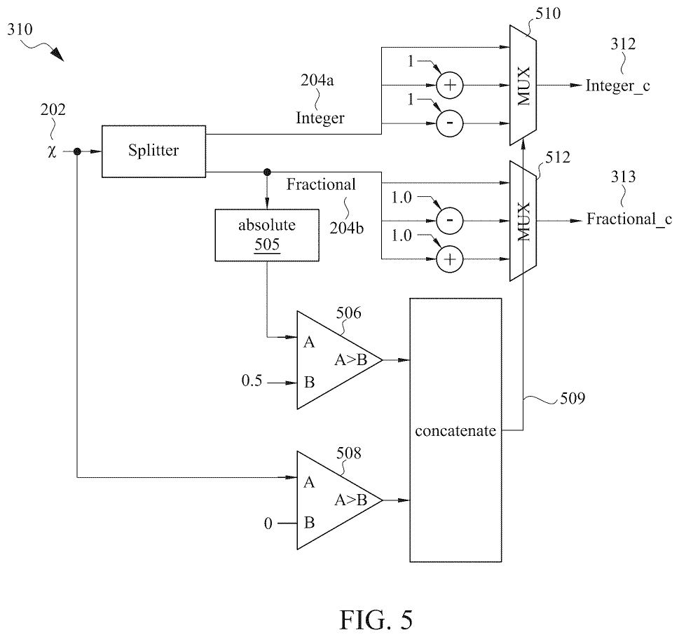

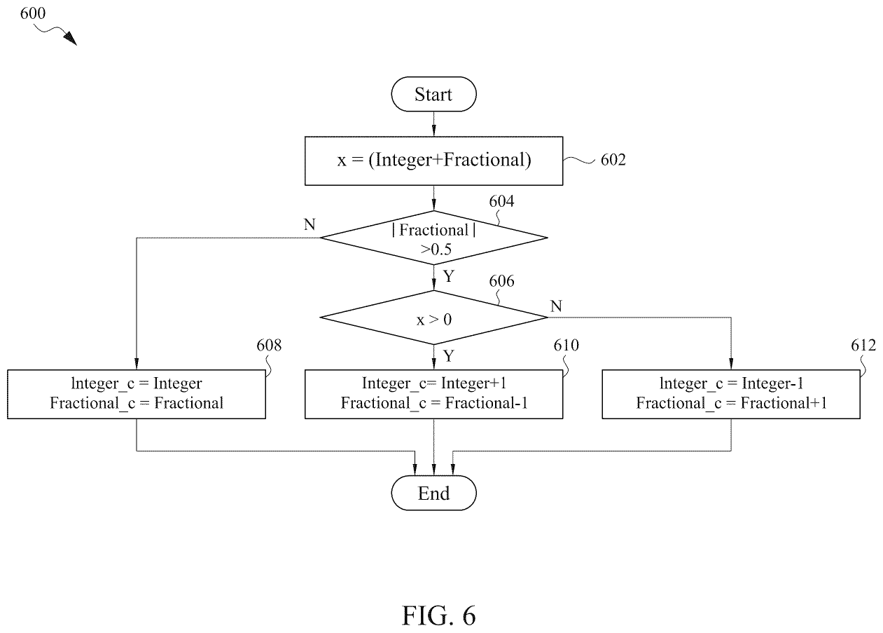

FIG. 3 is a simplified diagram illustrating an alternative example structure of an exponential computation circuit, according to one or more embodiments described herein. Instead of using a fixed number of Taylor expansion terms for the fractional part output from the splitter circuit 204, a compensation circuit 310 is configured to generate a compensated integer part 312 (integer_c) and a compensated fractional part (fractional_c) 313 such that 0≤|fractional_c|≤0.5. Additional structure and operations of the compensation circuit 310 may be described below in relation to FIGS. 5-6.

In one embodiment, a Taylor term scheduler circuit 315 may receive the entirety, or at least a part 314 of the compensated fractional part 313, based on which to dynamically determine a number of Taylor terms needed for this particular compensated fractional part 313. This dynamically determined number of Taylor terms 318 is then passed to the Taylor computation circuit 212, which in turn only computes the dynamically determined N terms of the Taylor expansion of the exponential of the compensated fractional part 313. Tables 1 and 2 below provide examples of dynamically determined N terms of the Taylor expansion of different fractional parts, e.g., without compensation vs. with compensation.

TABLE 1
Dynamically Taylor Term Settings (Without Compensation)

| | # of Taylor terms | FRAC range | |
|---|---|---|---|
| Dynamic Talor Setting #1 | | | |
| EXP <= 5′d11 | 2 | | <0.125 |
| EXP = 5′d12 | 4 | 0.125 | 0.25 |
| EXP = 5′d13 | 5 | 0.25 | 0.5 |
| Else | 6 | >0.5 | |
| Dynamic Talor Setting #2 | | | |
| EXP <= 5′d11 | 2 | | <0.125 |
| EXP <= 8′d13 | 4 | 0.125 | 0.5 |
| EXP = 5′d14& MAN[9] = 1′b0 | 5 | 0.5 | 0.75 |
| Else | 6 | >0.75 | |
| Dynamic Talor Setting #3 | | | |
| EXP <= 5′d12 | 2 | | <0.25 |
| EXP <= 8′d13 | 4 | 0.25 | 0.5 |
| EXP = 5′d14&& (MAN[0] = 0 | 5 | 0.5 | 0.8745 |
| \| \|MAN[9:8] = 10) | | | |
| Else | 6 | >0.8745 | |
| Dynamic Talor Setting #4 | | | |
| EXP <= 5′d13 | 2 | | <0.5 |
| EXP = 5′d14&& MAN[9] = 0 | 4 | 0.5 | 0.75 |
| EXP = 5′d14&& MAN[9:8] = 10 | 5 | 0.75 | 0.8745 |
| Else | 6 | >0.8745 | |

TABLE 2
Dynamically Taylor Term Settings (With Compensation)

| | # of Taylor terms | FRAC range | |
|---|---|---|---|
| Dynamic Talor Setting #1 | | | |
| EXP <= 5′d11 | 2 | | <0.125 |
| EXP = 5′d12 | 4 | 0.125 | 0.25 |
| EXP = 5′d13 | 5 | 0.25 | 0.5 |
| Dynamic Talor Setting #2 | | | |
| EXP <= 5′d11 | 2 | | <0.125 |
| EXP <= 8′d13 | 4 | 0.125 | 0.5 |
| Dynamic Talor Setting #3 | | | |
| EXP <= 5′d12 | 2 | | <0.25 |
| EXP <= 8′d13 | 4 | 0.25 | 0.5 |
| Dynamic Talor Setting #4 | | | |
| EXP <= 5′d13 | 2 | | <0.5 |

As shown in Tables 1 and 2, using the compensation circuit 310 to restrict the fractional part to be less than 0.5 further reduces the number of Talor expansion terms, while maintaining computational accuracy. Therefore, the combination of compensation circuit 310 and the Taylor term scheduler circuit 315 jointly improves computational efficiency of the exponential computation circuit.

For the compensated integer part 312, the exponential of the compensated integer part 316 is retrieved by the LUT circuit 210 in a similar manner as described in FIG. 2. The exponential of the integer part 316 and the exponential of the compensated fractional part 317 are then multiplied by the multiplier 220 to generate output 330 as the exponential of input 202.

FIG. 4 is a simplified diagram illustrating an example structure of a splitter circuit 204 described in FIG. 3, according to one or more embodiments described herein. The splitter circuit 204 may comprise a shift counter 402, a shifter 404, a sign combiner 410 and a normalization circuit 412.

In one embodiment, the input data value 202, e.g., in BF16 or FP16 data format, may be decomposed into its sign 202a, mantissa 202c, and exponent 202b. For example, when the input data value 202 takes a format of BF16, bit 0 to bit 6 (7 bits) represent the mantissa 202c, bit 7 to bit 14 (8 bits) represent the exponent 202b and the last bit represents the sign 202a. The shifter counter 402 may then shift a number of bits for the exponent bits 202b, resulting in the number of shifted bits 402, a fractional flag part 405 (indicating whether a fractional part exists). For example, if the magnitude of input data value is smaller than 1, then fractional flag 405 frac_flag=1, and the unsigned integer part 407 is set to 0, and the unsigned fractional part 408 equals the input data value.

Both of these outputs from the shift counter 402 are then passed to the shifter circuit 404, together with the mantissa bits 202c. The shifter circuit 404 may then shift bits to generate an unsigned integer part 407, and an unsigned fractional part 408.

The sign combiner circuit 410 may combine the sign bit 202a, the fractional flag 405 and the unsigned integer 407 to output the integer part 204a. The normalization circuit 412 may in turn combine the sign bit 202a, the fractional flag 405 and the unsigned fractional part 408, and in turn normalizes the unsigned fractional part 408 to output the fractional part 204b.

FIG. 5 is a simplified diagram illustrating an example structure of a compensation circuit 310 described in FIG. 3, and FIG. 6 provides a simplified logic flow diagram illustrating a workflow 600 of the compensation circuit 310 described in FIG. 5, according to one or more embodiments described herein. For example, the compensation circuit 310 may comprise multiple comparators 506, 508, and multiple multiplexers 510, 512.

After the splitter circuit splitting the input 202 into the integer part 204a and the fractional part 204b, e.g., at step 602 in FIG. 6, the magnitude (absolute value) of the factional part 204b is taken at the absolute circuit 505. A comparator 506 then compares the magnitude (absolute value) of the factional part 204b with the pre-defined threshold 0.5, e.g. at step 604 of FIG. 6. Another comparator 508 compares the input value 202 with 0 to, e.g., at step 606 of FIG. 6. Outputs of comparator 506, e.g., a first bit indicating whether the magnitude (absolute value) of the factional part 204b is greater than 0.5, and of comparator 508, e.g., a second bit indicating whether the input data value 202 is greater than 0, may be concatenated into a two-bit control signal 509.

The control signal 509 is sent to a first multiplexer 510 and a second multiplexer 510 to select an output accordingly. For example, when the control signal 509 is “00” or “01,” indicating |fractional|<0.5, the first multiplexer 510 selects an output to be the integer part 204a and the second multiplexer 512 selects an output to be the fractional part 204b, e.g., at step 608 in FIG. 6. In this case, the compensated integer part 312 and the compensated fractional part 313 are the same as the uncompensated integer part 204a and the uncompensated fractional part 204b, respectively.

For another example, when the control signal 509 is “10,” indicating |fractional|>0.5 but input data x<0, the first multiplexer 510 selects an output to be the integer part 204a minus 1 and the second multiplexer 512 selects an output to be the fractional part 204b plus 1, e.g., at step 612 in FIG. 6. In this case, the compensated integer part 312 and the compensated fractional part 313 are set to be (uncompensated integer part 204a−1) and (uncompensated fractional part 204b+1), respectively.

For another example, when the control signal 509 is “11,” indicating |fractional|>0.5 but input data x>0, the first multiplexer 510 selects an output to be the integer part 204a+1 and the second multiplexer 512 selects an output to be the fractional part 204b−1, e.g., at step 610 in FIG. 6. In this case, the compensated integer part 312 and the compensated fractional part 313 are set to be (uncompensated integer part 204a+1) and (uncompensated fractional part 204b−1), respectively.

In this way, the compensated fractional part 313 is restricted to be smaller than 0.5, which reduces the number of terms needed in Taylor expansion computation, reducing the computation cycle and energy consumption.

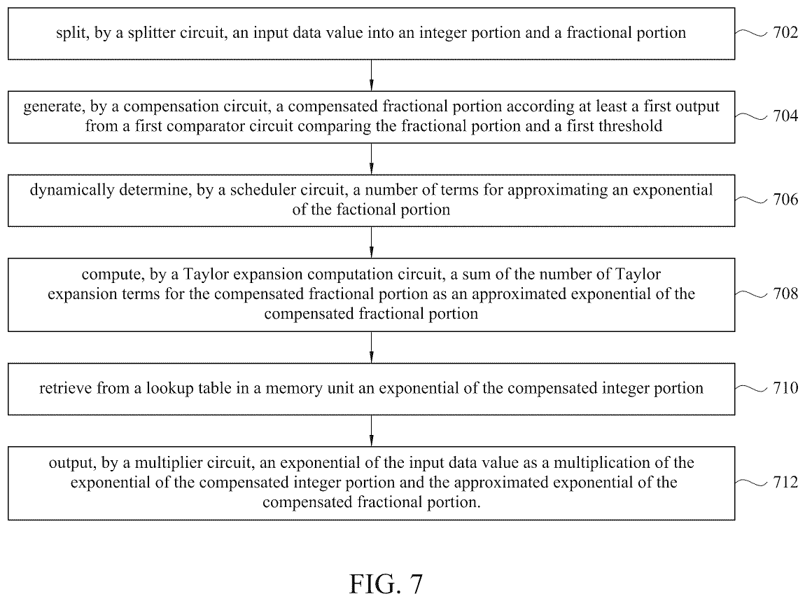

FIG. 7 is an example logic flow chart illustrating a process 700 for operating an exponential computation circuit described in FIGS. 1-6, according to embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the exponential computation circuits shown in FIGS. 1-6.

As illustrated, the method 700 includes a number of enumerated steps, but aspects of the method 700 may include additional steps before, after, and in between the enumerated steps. In some respects, one or more of the enumerated steps may be omitted or performed in a different order.

At step 702, a splitter circuit (e.g., 204 in FIG. 3) may split an input data value (e.g., 202 in FIG. 3) into an integer portion (e.g., 204a in FIG. 3) and a fractional portion (e.g., 204b in FIG. 3). For example, the input data value comprises a first bit indicating a sign of the input data value, a first set of bits indicating an exponent of the input data value, and a second set of bits indicating a mantissa of the input data value.

At step 704, a compensation circuit (e.g., 310 in FIGS. 3 and 5) may generate a compensated fractional portion (e.g., 313 in FIGS. 3 and 5) according at least a first output from a first comparator circuit (e.g., 506 in FIG. 5) comparing the fractional portion (e.g., 204b in FIG. 5) and a first threshold. For example, the first comparator circuit (e.g., 506 in FIG. 0.5) generates the first output comparing an absolute value of the fractional portion and a first threshold. A second comparator circuit (e.g., 508 in FIG. 5) generates a second output comparing at least a first bit of the input data value and zero. A first multiplexer (e.g., 510 in FIG. 5) may selectively output a compensated integer portion from the integer portion, the integer portion plus one or minus one, according to a concatenation (e.g., 509 in FIG. 5) of the first output and the second output. A second multiplexer (e.g., 512 in FIG. 5) may selectively output a compensated fractional portion from the fractional portion, the fractional portion plus one or minus one, according to the concatenation of the first output and the second output.

At step 706, a scheduler circuit (e.g., 315 in FIG. 3) may dynamically determine a number of terms for approximating an exponential of the factional portion. For example, the scheduler circuit may comprise one or more comparator circuits (not shown in FIG. 3) to compare the compensated fractional portion with a respective pre-defined threshold thereby generating a respective comparison output indicating whether the compensated fractional portion is within a respective range. The scheduler circuit may further comprise a multiplexer to select one of a plurality of pre-defined quantities (e.g., 2, 4, 5, 6, as shown in Tables 1-2) according to respective comparison outputs from the one or more comparator circuits.

At step 708, a Taylor expansion computation circuit (e.g., 212 in FIG. 3) may compute a sum of the number of Taylor expansion terms for the compensated fractional portion as an approximated exponential of the compensated fractional portion.

At step 710, a LUT circuit (e.g., 210 in FIG. 3) may retrieve from a lookup table in the memory unit an exponential of a compensated integer portion.

At step 712, a multiplier circuit (e.g., 220 in FIG. 3) may compute an exponential of the input data value as a multiplication of an exponential of the compensated integer portion (e.g., 316 in FIG. 3) and the approximated exponential of the compensated fractional portion (e.g., 317 in FIG. 3).

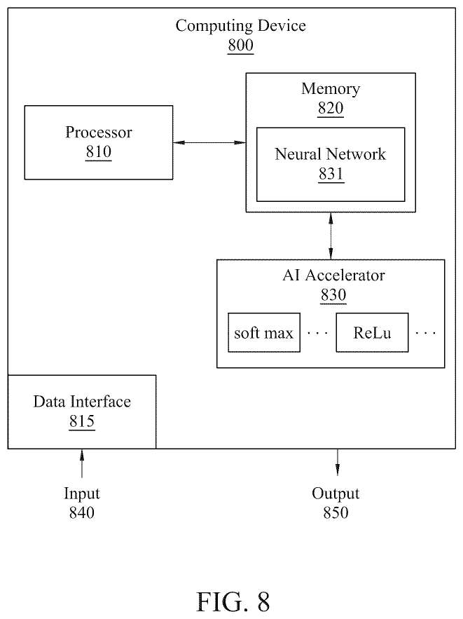

FIG. 8 is a simplified diagram illustrating a computing device implementing a neural network on an AI accelerator comprising the circuit structures described in FIGS. 1-7, according to one embodiment described herein. As shown in FIG. 8, computing device 800 includes a processor 810 coupled to memory 820. Operation of computing device 800 is controlled by processor 810. And although computing device 800 is shown with only one processor 810, it is understood that processor 810 may be representative of one or more central processing units, microcontrollers, multi-core processors, microprocessors, microcontrollers, digital signal processors, field programmable gate arrays (FPGAs), application specific integrated circuits (ASICs), graphics processing units (GPUs) and/or the like in computing device 800. Computing device 800 may be implemented as a stand-alone subsystem, as a board added to a computing device, and/or as a virtual machine.

Memory 820 may be used to store software executed by computing device 800 and/or one or more data structures used during operation of computing device 800. Memory 820 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 810 and/or memory 820 may be arranged in any suitable physical arrangement. In some embodiments, processor 810 and/or memory 820 may be implemented on a same board, in a same package (e.g., system-in-package), on a same chip (e.g., system-on-chip), and/or the like. In some embodiments, processor 810 and/or memory 820 may include distributed, virtualized, and/or containerized computing resources. Consistent with such embodiments, processor 810 and/or memory 820 may be located in one or more data centers and/or cloud computing facilities.

In another embodiment, processor 810 may comprise multiple microprocessors and/or memory 820 may comprise multiple registers and/or other memory elements such that processor 810 and/or memory 820 may be arranged in the form of a hardware-based neural network, as further described in FIGS. 1-6.

In some examples, memory 820 may include non-transitory, tangible, machine readable media that includes executable code that when run by one or more processors (e.g., processor 810) may cause the one or more processors to perform the methods described in further detail herein. For example, as shown, memory 820 includes instructions for operating a neural network 831.

Memory 802 may further couple to an AI accelerator 830, which may comprise ALUs such as softmax, ReLU, SiLU, and/or the like. The ALUs of AI accelerator 803 may comprise one or more exponential computation circuits as described in FIGS. 3-6.

The data interface 815 may comprise a communication interface, a user interface (such as a voice input interface, a graphical user interface, and/or the like). For example, the computing device 800 may receive the input 840 (such as a training dataset) from a networked database via a communication interface. Or the computing device 800 may receive the input 840, such as an input image, from a user via the user interface, and generate an output 850 (such as 130 in FIG. 1).

Some examples of computing devices, such as computing device 1400 may include non-transitory, tangible, machine readable media that include executable code that when run by one or more processors (e.g., processor 1410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Computing device 800 may be comprised in a system for running one or more neural networks. The system comprises a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion.

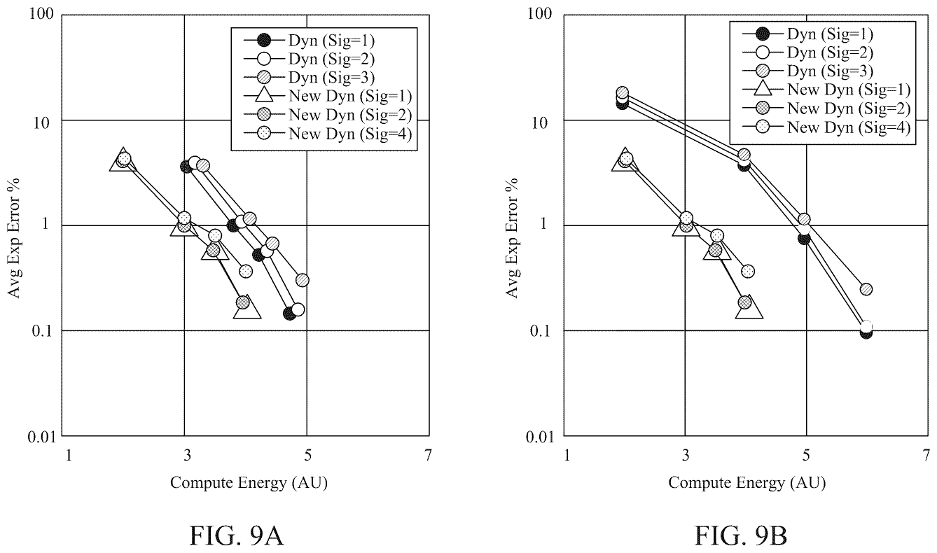

FIGS. 9A-9B are example performance charts illustrating error and power efficiency of the exponential computation circuit described in FIGS. 1-8, according to one embodiment described herein. FIG. 9A shows the computation circuit shown in FIG. 3 may reduce at least 18% of compute energy with compensation circuit 310 (e.g., with legend “new dyn,” standard deviation of the tested random data “sign”=1, 2, 4) compared to a scheme without compensation (e.g., with legend “dyn,” standard deviation of the tested random data “sign”=1, 2, 4). FIG. 9B shows the computation circuit shown in FIG. 3 may achieve a 5.6 times reduction in error and 30% reduction in energy consumption with compensation circuit 310 (e.g., with legend “new dyn,” standard deviation of the tested random data “sign”=1, 2, 4) compared to a scheme without compensation (e.g., with legend “dyn,” standard deviation of the tested random data “sign”=1, 2, 4).

In one exemplary aspect, the present disclosure is directed to a circuit for performing computations of input data in a neural network. The circuit includes a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion. In some embodiments, the input data value comprises a first bit indicating a sign of the input data value, a first set of bits indicating an exponent of the input data value, and a second set of bits indicating a mantissa of the input data value. In some embodiments, the splitter circuit includes one or more shifter circuits that generate an unsigned integer portion and an unsigned fractional portion from the first set of bits and the second set of bits, a sign combiner circuit to generate the integer portion by combining the first bit with the unsigned integer portion, and a normalization circuit to generate the fractional circuit based on the first bit and the unsigned fractional portion. In some embodiments, the compensation circuit includes the first comparator circuit generating the first output comparing an absolute value of the fractional portion and a first threshold, a second comparator circuit generating a second output comparing at least a first bit of the input data value and zero, a first multiplexer selectively outputting a compensated integer portion from the integer portion, the integer portion plus one or minus one, according to a concatenation of the first output and the second output, and a second multiplexer selectively outputting a compensated fractional portion from the fractional portion, the fractional portion plus one or minus one, according to the concatenation of the first output and the second output. In some embodiments, the scheduler circuit includes one or more comparator circuits, each comparing the compensated fractional portion with a respective pre-defined thresholds thereby generating a respective comparison output indicating whether the compensated fractional portion is within a respective range, and a multiplexer selectively outputting one of a plurality of pre-defined quantities according to respective comparison outputs from the one or more comparator circuits. In some embodiments, the Taylor expansion computation circuit computes the sum of the number of Taylor expansion terms as an approximated exponential of the compensated fractional portion. In some embodiments, the circuit further includes a microcontroller retrieving from a lookup table in a memory unit an exponential of the compensated integer portion. In some embodiments, the circuit further includes a multiplier circuit outputting an exponential of the input data value as a multiplication of the exponential of the compensated integer portion and the approximated exponential of the compensated fractional portion. In some embodiments, the circuit further includes an artificial intelligence (AI) accelerator circuit comprising an arithmetic logic unit (ALU) computing a transformation of the input data value based on the exponential of the input data value when the input data value is part of an input to a neural network.

In another exemplary aspect, the present disclosure is directed to a method of operating an application-specific integrated circuit (ASIC) for performing computation of input data. The method includes splitting, by a splitter circuit, an input data value into an integer portion and a fractional portion, generating, by a compensation circuit, a compensated fractional portion according at least a first output from a first comparator circuit comparing the fractional portion and a first threshold, dynamically determining, by a scheduler circuit, a number of terms for approximating an exponential of the factional portion, computing, by a Taylor expansion computation circuit, a sum of the number of Taylor expansion terms for the compensated fractional portion as an approximated exponential of the compensated fractional portion, and outputting, by a multiplier circuit, an exponential of the input data value as a multiplication of an exponential of the compensated integer portion and the approximated exponential of the compensated fractional portion. In some embodiments, the input data value comprises a first bit indicating a sign of the input data value, a first set of bits indicating an exponent of the input data value, and a second set of bits indicating a mantissa of the input data value. In some embodiments, generating, by the compensation circuit, the compensated fractional portion includes generating, by the first comparator circuit, the first output comparing an absolute value of the fractional portion and a first threshold, generating, a second comparator circuit, a second output comparing at least a first bit of the input data value and zero, selectively outputting, by a first multiplexer, a compensated integer portion from the integer portion, the integer portion plus one or minus one, according to a concatenation of the first output and the second output, and selectively outputting, by a second multiplexer, a compensated fractional portion from the fractional portion, the fractional portion plus one or minus one, according to the concatenation of the first output and the second output. In some embodiments, dynamically determining, by the scheduler circuit, the number of terms includes comparing, by each of one or more comparator circuits, the compensated fractional portion with a respective pre-defined thresholds thereby generating a respective comparison output indicating whether the compensated fractional portion is within a respective range, and selectively outputting, by a multiplexer, one of a plurality of pre-defined quantities according to respective comparison outputs from the one or more comparator circuits. In some embodiments, the method further includes retrieving from a lookup table in a memory unit an exponential of the compensated integer portion. In some embodiments, the method further includes outputting, by a multiplier circuit, an exponential of the input data value as a multiplication of the exponential of the compensated integer portion and the approximated exponential of the compensated fractional portion.

In yet another exemplary aspect, the present disclosure is directed to a system running one or more neural networks. The system includes a splitter circuit splitting an input data value into an integer portion and a fractional portion, a compensation circuit generating a compensated fractional portion according at least a first output from a first comparator circuit comparing the fractional portion and a first threshold, a scheduler circuit dynamically determining a number of terms for approximating an exponential of the factional portion, and a Taylor expansion computation circuit computing a sum of the number of Taylor expansion terms for the compensated fractional portion. In some embodiments, the compensation circuit includes the first comparator circuit generating the first output comparing an absolute value of the fractional portion and a first threshold, a second comparator circuit generating a second output comparing at least a first bit of the input data value and zero, a first multiplexer selectively outputting a compensated integer portion from the integer portion, the integer portion plus one or minus one, according to a concatenation of the first output and the second output, and a second multiplexer selectively outputting a compensated fractional portion from the fractional portion, the fractional portion plus one or minus one, according to the concatenation of the first output and the second output. In some embodiments, the scheduler circuit includes one or more comparator circuits, each comparing the compensated fractional portion with a respective pre-defined thresholds thereby generating a respective comparison output indicating whether the compensated fractional portion is within a respective range, and a multiplexer selectively outputting one of a plurality of pre-defined quantities according to respective comparison outputs from the one or more comparator circuits. In some embodiments, the Taylor expansion computation circuit computes the sum of the number of Taylor expansion terms as an approximated exponential of the compensated fractional portion. The system further includes a microcontroller retrieving from a lookup table in a memory unit an exponential of the compensated integer portion. In some embodiments, the system further includes a multiplier circuit outputting an exponential of the input data value as a multiplication of the exponential of the compensated integer portion and the approximated exponential of the compensated fractional portion.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A circuit for performing computations of input data in a neural network, comprising:
a splitter circuit splitting an input data value into an integer portion and a fractional portion;
a compensation circuit generating a compensated fractional portion according at least a first output from a first comparator circuit comparing the fractional portion and a first threshold;
a scheduler circuit dynamically determining a number of terms for approximating an exponential of the factional portion; and
a Taylor expansion computation circuit computing a sum of the number of Taylor expansion terms for the compensated fractional portion.

2. The circuit of claim 1, wherein the input data value comprises a first bit indicating a sign of the input data value, a first set of bits indicating an exponent of the input data value, and a second set of bits indicating a mantissa of the input data value.

3. The circuit of claim 2, wherein the splitter circuit comprises:
one or more shifter circuits that generate an unsigned integer portion and an unsigned fractional portion from the first set of bits and the second set of bits;
a sign combiner circuit to generate the integer portion by combining the first bit with the unsigned integer portion; and
a normalization circuit to generate the fractional circuit based on the first bit and the unsigned fractional portion.

4. The circuit of claim 1, wherein the compensation circuit comprises:
the first comparator circuit generating the first output comparing an absolute value of the fractional portion and a first threshold,
a second comparator circuit generating a second output comparing at least a first bit of the input data value and zero,
a first multiplexer selectively outputting a compensated integer portion from the integer portion, the integer portion plus one or minus one, according to a concatenation of the first output and the second output, and
a second multiplexer selectively outputting a compensated fractional portion from the fractional portion, the fractional portion plus one or minus one, according to the concatenation of the first output and the second output.

5. The circuit of claim 1, wherein the scheduler circuit comprises:
one or more comparator circuits, each comparing the compensated fractional portion with a respective pre-defined thresholds thereby generating a respective comparison output indicating whether the compensated fractional portion is within a respective range; and
a multiplexer selectively outputting one of a plurality of pre-defined quantities according to respective comparison outputs from the one or more comparator circuits.

6. The circuit of claim 1, wherein the Taylor expansion computation circuit computes the sum of the number of Taylor expansion terms as an approximated exponential of the compensated fractional portion.

7. The circuit of claim 1, further comprising:
a microcontroller retrieving from a lookup table in a memory unit an exponential of the compensated integer portion.

8. The circuit of claim 7, further comprising:
a multiplier circuit outputting an exponential of the input data value as a multiplication of the exponential of the compensated integer portion and the approximated exponential of the compensated fractional portion.

9. The circuit of claim 8, further comprising:
an artificial intelligence (AI) accelerator circuit comprising an arithmetic logic unit (ALU) computing a transformation of the input data value based on the exponential of the input data value when the input data value is part of an input to a neural network.

10. A method of operating an application-specific integrated circuit (ASIC) for performing computation of input data, comprising:
splitting, by a splitter circuit, an input data value into an integer portion and a fractional portion;
generating, by a compensation circuit, a compensated fractional portion according at least a first output from a first comparator circuit comparing the fractional portion and a first threshold;
dynamically determining, by a scheduler circuit, a number of terms for approximating an exponential of the factional portion;
computing, by a Taylor expansion computation circuit, a sum of the number of Taylor expansion terms for the compensated fractional portion as an approximated exponential of the compensated fractional portion; and
outputting, by a multiplier circuit, an exponential of the input data value as a multiplication of an exponential of the compensated integer portion and the approximated exponential of the compensated fractional portion.

11. The method of claim 10, wherein the input data value comprises a first bit indicating a sign of the input data value, a first set of bits indicating an exponent of the input data value, and a second set of bits indicating a mantissa of the input data value.

12. The method of claim 10, wherein generating, by the compensation circuit, the compensated fractional portion comprises:
generating, by the first comparator circuit, the first output comparing an absolute value of the fractional portion and a first threshold,
generating, a second comparator circuit, a second output comparing at least a first bit of the input data value and zero,
selectively outputting, by a first multiplexer, a compensated integer portion from the integer portion, the integer portion plus one or minus one, according to a concatenation of the first output and the second output, and
selectively outputting, by a second multiplexer, a compensated fractional portion from the fractional portion, the fractional portion plus one or minus one, according to the concatenation of the first output and the second output.

13. The method of claim 10, wherein dynamically determining, by the scheduler circuit, the number of terms comprises:
comparing, by each of one or more comparator circuits, the compensated fractional portion with a respective pre-defined thresholds thereby generating a respective comparison output indicating whether the compensated fractional portion is within a respective range; and
selectively outputting, by a multiplexer, one of a plurality of pre-defined quantities according to respective comparison outputs from the one or more comparator circuits.

14. The method of claim 10, further comprising:
retrieving from a lookup table in a memory unit an exponential of the compensated integer portion.

15. The method of claim 14, further comprising:
outputting, by a multiplier circuit, an exponential of the input data value as a multiplication of the exponential of the compensated integer portion and the approximated exponential of the compensated fractional portion.

16. A system running one or more neural networks, comprising:
a splitter circuit splitting an input data value into an integer portion and a fractional portion;
a compensation circuit generating a compensated fractional portion according at least a first output from a first comparator circuit comparing the fractional portion and a first threshold;
a scheduler circuit dynamically determining a number of terms for approximating an exponential of the factional portion; and
a Taylor expansion computation circuit computing a sum of the number of Taylor expansion terms for the compensated fractional portion.

17. The system of claim 16, wherein the compensation circuit comprises:
the first comparator circuit generating the first output comparing an absolute value of the fractional portion and a first threshold,
a second comparator circuit generating a second output comparing at least a first bit of the input data value and zero,
a first multiplexer selectively outputting a compensated integer portion from the integer portion, the integer portion plus one or minus one, according to a concatenation of the first output and the second output, and
a second multiplexer selectively outputting a compensated fractional portion from the fractional portion, the fractional portion plus one or minus one, according to the concatenation of the first output and the second output.

18. The system of claim 16, wherein the scheduler circuit comprises:
one or more comparator circuits, each comparing the compensated fractional portion with a respective pre-defined thresholds thereby generating a respective comparison output indicating whether the compensated fractional portion is within a respective range; and
a multiplexer selectively outputting one of a plurality of pre-defined quantities according to respective comparison outputs from the one or more comparator circuits.

19. The system of claim 16, wherein the Taylor expansion computation circuit computes the sum of the number of Taylor expansion terms as an approximated exponential of the compensated fractional portion, and wherein the system further comprises:
a microcontroller retrieving from a lookup table in a memory unit an exponential of the compensated integer portion.

20. The system of claim 19, further comprising:
a multiplier circuit outputting an exponential of the input data value as a multiplication of the exponential of the compensated integer portion and the approximated exponential of the compensated fractional portion.
